(19) United States
(12) Patent Application Publication
(10) Pub. No.: US 2026/0104303 A1
(43) Pub. Date: Apr. 16, 2026

(54) RHEOMETER NORMAL FORCE MEASUREMENT

(71) Applicant: TA Instruments-Waters LLC, New Castle, DE (US)

(72) Inventor: Christopher Cochoff, Wilmington, DE (US)

(21) Appl. No.: 19/357,669

(22) Filed: Oct. 14, 2025

Related U.S. Application Data
(60) Provisional application No. 63/707,439, filed on Oct. 15, 2024.

(51) Int. Cl. G01L 5/12; G01L 5/00; G01N 3/06; G01N 3/307

(52) U.S. Cl. CPC G01L 5/12; G01L 5/0009; G01N 3/064; G01N 3/307

(57) ABSTRACT

A rheometer shaft system includes an output shaft including an axial thrust disk, an upper air bearing surrounding the output shaft located above the axial thrust disk, and a lower air bearing surrounding the output shaft located below the axial thrust disk. An upper gap separates the axial thrust disk of the output shaft and the upper air bearing. A lower gap separates the axial thrust disk of the output shaft and the lower air bearing. An airflow detection system is configured to detect a change in airflow to the upper air bearing and the lower air bearing based on the movement in the axial direction of the output shaft. This change in airflow can be used to monitor normal force applied to the rheometer shaft.

### RELATED APPLICATION

This application claims priority to U.S. Provisional Ser. No. 63/707,439 filed on Oct. 15, 2024 and titled “Rhepmeter Normal Force Measurement” the entirety of which is incorporated by reference herein.

### FIELD OF THE INVENTION

The disclosed technology generally relates to rheometers. More particularly, the technology relates to the measurement of normal forces on a shaft of a rheometer.

### BACKGROUND

On a rheometer, measuring the normal force applied to a shaft provides useful data to users and can be used to protect bearings from excessive force being applied by the gap control system. In the case of air bearings, exerting a greater force than what the air film can exert on the shaft can cause grinding that may damage the bearing and reduce the performance of the rheometer. A common case in which this may occur is during sample loading. High viscosity samples take time to relax and can apply high forces to the shaft, which will exceed the load capacity of the bearing until the sample has sufficiently relaxed. Existing solutions to manage bearing normal force are quite costly and add significant complexity to the system design.

Therefore, improved devices and methods for measuring normal force on the shaft of a rheometer would be well received in the art.

### SUMMARY

In one aspect, a rheometer shaft system includes an output shaft including an axial thrust disk; an upper air bearing surrounding the output shaft located above the axial thrust disk, where an upper gap separates the axial thrust disk of the output shaft and the upper air bearing; a lower air bearing surrounding the output shaft located below the axial thrust disk, where a lower gap separates the axial thrust disk of the output shaft and the lower air bearing, where the output shaft is configured to move in an axial direction relative to the upper and lower air bearings in response to a normal force such that movement in the axial direction reduces one of the upper and lower gap and increases the other of the upper and lower gap; an air supply system configured to provide an airflow to each of the upper air bearing and the lower air bearing; and an airflow detection system configured to detect a change in airflow to the upper air bearing and the lower air bearing based on the movement in the axial direction.

Additionally or alternatively, the airflow detection system further includes a first pressure sensor fluidically connected with a first fluidic channel of the air supply system connected to the upper air bearing, the first pressure sensor configured to detect a first pressure in the first fluidic channel; and a second pressure sensor fluidically connected with a second fluidic channel of the air supply system connected to the lower air bearing, the second pressure sensor configured to detect a second pressure in the second fluidic channel. The first pressure sensor and the second pressure sensors may be differential pressure sensors. Further, the airflow direction system may further include a first reduced orifice located upstream from the first pressure sensor in the air supply system configured to create a controlled pressure drop in the first fluidic channel connected to the upper air bearing; and a second reduced orifice located upstream from the second pressure sensor in the air supply system configured to create a controlled pressure drop in the second fluidic channel connected to the lower air bearing. The airflow detection system may alternatively include a first airflow restrictor structure located upstream from the first pressure sensor in the air supply system configured to create a controlled pressure drop in the first fluidic channel connected to the upper air bearing, and a second airflow restrictor structure located upstream from the second pressure sensor in the air supply system configured to create a controlled pressure drop in the second fluidic channel connected to the lower air bearing.

Additionally or alternatively, the airflow detection system further includes a first airflow sensor fluidically connected with a first fluidic channel of the air supply system connected to the upper air bearing, the first airflow sensor configured to detect a first total airflow through the first fluidic channel; and a second airflow sensor fluidically connected with a second fluidic channel of the air supply system connected to the lower air bearing, the second airflow sensor configured to detect a second total airflow through the second fluidic channel.

Additionally or alternatively, the rheometer shaft system further includes a gap control system configured to vertically move the output shaft, the upper bearing and the lower bearing in order to control the position of a geometry located at an end of the output shaft relative to a sample test location. The gap control system may be configured to automatically respond to a detected change in airflow to the upper air bearing and the lower air bearing based on the movement in the axial direction of the shaft relative to the upper and lower air bearings. The gap control system may further be configured to prevent the upper air bearing and the lower air bearing from contacting the axial thrust disk by stopping vertical movement of the output shaft, the upper bearing and the lower bearing in response to the detected change in airflow to the upper air bearing and the lower air bearing based on the movement in the axial direction of the shaft relative to the upper and lower air bearings.

In another aspect, a rheometer system includes a sample test location; and a rheometer shaft system includes an output shaft including an axial thrust disk; an upper air bearing surrounding the output shaft located above the axial thrust disk, where an upper gap separates the axial thrust disk of the output shaft and the upper air bearing; a lower air bearing surrounding the output shaft located below the axial thrust disk, where a lower gap separates the axial thrust disk of the output shaft and the lower air bearing, where the output shaft is configured to move in an axial direction relative to the upper and lower air bearings in response to a normal force such that movement in the axial direction reduces one of the upper and lower gap and increases the other of the upper and lower gap; an air supply system configured to provide an airflow to each of the upper air bearing and the lower air bearing; and an airflow detection system configured to detect a change in airflow to the upper air bearing and the lower air bearing based on the movement in the axial direction. The rheometer system further includes a sensor system configured to detect measurements from the rheometer shaft system associated with interactions between a test sample in the sample test location and a geometry attached to an end of the output shaft; and a processing system in communication with the sensor system, the processing system configured to provide for instrument control, data collection and data analysis based on the detected measurements.

Additionally or alternatively, the rheometer system further includes a first pressure sensor fluidically connected with a first fluidic channel of the air supply system connected to the upper air bearing, the first pressure sensor configured to detect a first pressure in the first fluidic channel; and a second pressure sensor fluidically connected with a second fluidic channel of the air supply system connected to the lower air bearing, the second pressure sensor configured to detect a second pressure in the second fluidic channel. The first pressure sensor and the second pressure sensors may be differential pressure sensors. Further, the airflow direction system may further include a first reduced orifice located upstream from the first pressure sensor in the air supply system configured to create a controlled pressure drop in the first fluidic channel connected to the upper air bearing; and a second reduced orifice located upstream from the second pressure sensor in the air supply system configured to create a controlled pressure drop in the second fluidic channel connected to the lower air bearing. The airflow detection system may alternatively include a first airflow restrictor structure located upstream from the first pressure sensor in the air supply system configured to create a controlled pressure drop in the first fluidic channel connected to the upper air bearing, and a second airflow restrictor structure located upstream from the second pressure sensor in the air supply system configured to create a controlled pressure drop in the second fluidic channel connected to the lower air bearing.

Additionally or alternatively, the airflow detection system further includes a first airflow sensor fluidically connected with a first fluidic channel of the air supply system connected to the upper air bearing, the first airflow sensor configured to detect a first total airflow through the first fluidic channel; and a second airflow sensor fluidically connected with a second fluidic channel of the air supply system connected to the lower air bearing, the second airflow sensor configured to detect a second total airflow through the second fluidic channel.

Additionally or alternatively, the rheometer system further includes the geometry attached to the end of the output shaft configured to interact with the test sample in the sample test location.

In another aspect, a method of measuring a normal force on a shaft of a rheometer includes providing a rheometer shaft system that includes an output shaft including an axial thrust disk; an upper air bearing surrounding the output shaft located above the axial thrust disk, where an upper gap separates the axial thrust disk of the output shaft and the upper air bearing; a lower air bearing surrounding the output shaft located below the axial thrust disk, where a lower gap separates the axial thrust disk of the output shaft and the lower air bearing, where the output shaft is configured to move in an axial direction relative to the upper and lower air bearings in response to a normal force such that movement in the axial direction reduces one of the upper and lower gap and increases the other of the upper and lower gap; an air supply system configured to provide an airflow to each of the upper air bearing and the lower air bearing; and an airflow detection system configured to detect a change in airflow to the upper air bearing and the lower air bearing based on the movement in the axial direction. The method includes detecting, by the airflow detection system, the change in airflow to the upper air bearing and the lower air bearing based on the movement in the axial direction.

Additionally or alternatively, the method may include providing the detected change in airflow to the upper air bearing and the lower air bearing to the processing system of the rheometer system; and using the detected change in airflow for at least one of the instrument control and the data analysis.

Additionally or alternatively, the method may include automatically responding, by a gap control system of the rheometer system, to a detected change in airflow to the upper air bearing and the lower air bearing based on the movement in the axial direction of the shaft relative to the upper and lower air bearings.

Additionally or alternatively, the method may include preventing, by the gap control system of the rheometer system, the upper air bearing and the lower air bearing from contacting the axial thrust disk by stopping vertical movement of the output shaft, the upper bearing and the lower bearing in response to the detected change in airflow to the upper air bearing and the lower air bearing based on the movement in the axial direction of the shaft relative to the upper and lower air bearings.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic view of a rheometer, in accordance with one embodiment.

FIG. 2 depicts a schematic side view of a rheometer shaft, in accordance with one embodiment.

FIG. 3 depicts a schematic side view of a rheometer shaft system, in accordance with one embodiment.

FIG. 4 depicts a schematic side view of a rheometer shaft system, in accordance with one embodiment.

FIG. 5 depicts a schematic side view of a rheometer shaft system, in accordance with one embodiment.

FIG. 6 depicts a flow diagram of a method of measuring a normal force on a shaft of a rheometer, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein provide an airflow detection system configured to detect a change in airflow to an upper air bearing and a lower air bearing of a rheometer output shaft based on the movement in the axial direction of the rheometer output shaft, and then use that knowledge of this change in airflow to determine whether the upper and lower air bearings are approaching contact with an axial thrust disk of the output shaft. Embodiments described herein include a gap control system that is configured to prevent the upper air bearing and the lower air bearing from contacting the axial thrust disk by stopping vertical movement of the output shaft in response to the detected change in airflow to the upper air bearing and the lower air bearing based on the movement in the axial direction of the shaft relative to the upper and lower air bearings using airflow measurements.

Embodiments of the present invention recognize that prior art output shafts deploying air bearings rather than magnetic bearings provide no integrated way to measure the normal force applied to the shaft, which can present problems during sample loading and regular motion since there is no way to know if the bearings have made contact with the axial thrust disk leading to potential damaged air bearings.

Since an air bearing is compliant, it is contemplated herein to identify applied normal forces through the displacement of the output shaft and to measure the differential air pressure across the upper and lower axial bearings to monitor airflow changes resulting from the gap distance changing in the bearing as the output shaft (and axial thrust disk) moves up and down with force.

Specifically, as normal force is exerted on the output shaft, the axial thrust disk connected to the shaft begins to compress the air gap and/or air film coming from the opposing air bearing. This compression increases the pressure between the air bearing and the thrust disk and decreases the airflow out of the air bearing. The change in airflow through the air bearing can be correlated to the normal force the bearing is opposing. Specifically, normal force exerted onto the output shaft is resisted by an increase in air pressure between the opposing air bearing and the thrust disk. If the maximum thrust of the air bearing is exceeded by the external normal force, the axial thrust disk will grind against the graphite material of the air bearing, potentially causing damage—the present invention seeks to avoid this damage.

Thus, as normal force increases, the air pressure between the thrust disk and the air bearings increases and the airflow through the air bearing decreases. The difference in airflow between the top and bottom graphite is proportional to the normal force applied to the shaft. This correlation may be determined through a calibration process.

By measuring the difference in airflow between the upper and lower air bearings, force in either direction may be monitored, according to embodiments described herein. To measure the airflow difference, an orifice is placed in-line with each air bearing to create a controlled pressure drop and a differential pressure sensor measures the pressure difference between the upper and lower axial bearings after the orifices. Thus, present embodiments contemplate air restrictions being placed between the supply and the lower and upper axial bearings to create a pressure drop proportional to airflow, which is then measured via a differential pressure sensor. The airflow varies with temperature and the system air pressure, so the control systems contemplated herein may measure these values and compensate the normal force readings appropriately.

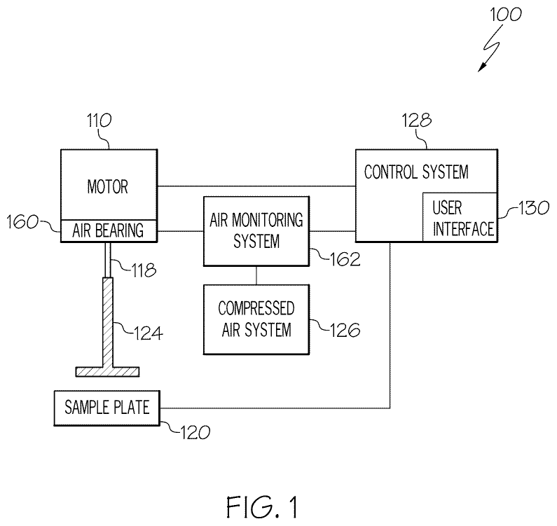

Embodiments of the present invention can be deployed with any rheological measurement system and/or methods of taking rheological measurements that use a rotatable shaft for attachment to a geometry for contacting or otherwise interacting with a sample. An exemplary rheological system is shown in FIG. 1. Specifically, FIG. 1 depicts a schematic view of a rheometer 100 in accordance with one embodiment. While the rheometer 100 includes various features described herein, it should be understood that the principles of the present invention may be applied to any other rheological measurement system configured to measure rheological properties having less or more than the schematic components shown in FIG. 1.

The rheometer 100 includes a drive motor 110 driving an output shaft 118 which is rotatable about an air bearing 160. A compressed air system 126 is configured to provide pressurized air to the air bearing 160. An air monitoring system 162 is operably connected to each of the compressed air system 126 and the air bearing and may be configured to monitor the airflow and/or air pressure to and from the air bearing 160 from the compressed air system 126. The rheometer 100 further includes a sample plate 120 configured to receive a sample for testing. While the embodiment shown includes a sample plate, in various embodiments, the sample plate 120 may be replaced by a sample chamber or walled sample holding system. It should be understood that the rheometer systems described herein may include any type of sample holding structure. In the event that the sample plate 120 is replaced by a sample chamber, it is contemplated that the compressed air system 126 may also provide pressurized air to pressurize the sample chamber during testing.

A control system 128 having a user interface 130 is shown operably connected to each of the drive motor 110, the air monitoring system 162 and the compressed air system 126. While the embodiment shown includes a single control system 128 for controlling the drive motor 110, the air monitoring system 162 and the compressed air system 126, other embodiments may include separate control systems. For example, the compressed air system 126 and air monitoring system 162 may include a separate manual or automatic control system that controls only the compressed air system 126 and the air monitoring system 162 in a manner that is independent from the drive motor 110.

The drive motor 110 may be configured to deliver accurate rotational motion of the output shaft 118 over a broad range of angular displacement and velocity. The drive motor 110 may, for example, include an air bearing system, a high-torque friction-free brushless DC motor, an optical encoder and a temperature sensing system. The drive motor 110, and the features thereof, may be controlled by the control system 128 and directed by inputs from the user interface 130.

The rheometer 100 further includes a rotor 124 attached to the output shaft 118 configured to interact with a sample located on the sample plate 120. In various embodiments, the sample plate 120 (or sample chamber), the rotor 124 and the compressed air system 126 may be integral components of the rheometer 100. Alternatively, it is contemplated that these components 120, 124, 126 are separately attachable add-on features of the rheometer 100. For example, the rotor 124 may be an add-on feature of the output shaft 118, which may be configured to receive any number of rotors or geometries. In some embodiments, the sample plate 120 may also be attachable to a motor and may be configured to also rotate independently from the output shaft 118. In embodiments where the sample plate 120 is replaced by a sample chamber, the rotor 124 may be configured to rotate within the sample chamber.

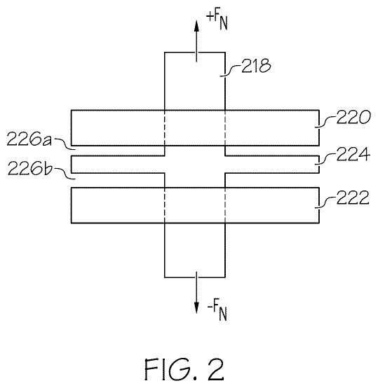

The air bearing system 160 is shown connected to the compressed air system 126 for receiving airflow into the air bearings. The air bearing system 160 may include at least two air bearings surrounding the output shaft 118 such that the output shaft 118 may rotate about the air bearings. Each of the air bearings may be located proximate a shaft thrust disk. The airflow detection system 162 may be configured to detect a change in airflow to an upper air bearing and a lower air bearing of the output shaft 118 based on the movement in the axial direction of the output shaft 118 relative to the fixed air bearings, and then use that knowledge of this change in airflow to determine whether the upper and lower air bearings are approaching contact with an axial thrust disk of the output shaft 118. This information may be provided to the control system 128, which may include a gap control system that is configured to prevent the upper air bearing and the lower air bearing from contacting the axial thrust disk by stopping vertical movement of the output shaft 118 in response to the detected change in airflow to the upper air bearing and the lower air bearing based on the movement in the axial direction of the output shaft 118 relative to the upper and lower air bearings using airflow measurements. Various embodiments of the air bearing system 160 and airflow detection system 162 will be described in more detail herein below with respect to FIGS. 2-6.

In addition to monitoring the airflow through the air bearings and determining whether the air bearings are approaching contact with the axial thrust disk of the output shaft 118, the control system 128 may also be configured to control and monitor the stresses, strains, forces, velocities, and the like, on the components of the system. The control system 128 may be configured to provide output information related to measurements conducted during testing of materials or samples within the sample chamber 122. The control system 128 may be configured to control motion of the output shaft 118, and further control the pressure within the sample chamber 122 through control of the compressed air system 126. The user interface 130 may be a screen or other input interface configured to allow a technician to interact with the rheometer 100, change settings, define test conditions, and the like.

FIG. 2 depicts a schematic side view of a rheometer output shaft 218, in accordance with one embodiment. The output shaft 218 may be the same or similar to the output shaft 118 and may be operably included in a rheometer system such as the rheometer 100 shown in FIG. 1. As shown, the output shaft 218 includes an axial thrust disk 224.

An upper air bearing 220 surrounds the output shaft 218 located above the axial thrust disk 224. An upper gap 226a separates the axial thrust disk 224 of the output shaft 218 and the upper air bearing 220. Similarly, a lower air bearing 222 surrounds the output shaft 218 located below the axial thrust disk 224. A lower gap 226b separates the axial thrust disk 224 of the output shaft 218 and the lower air bearing 222. The axial thrust disk 224 may be configured to hold the upper and lower air bearings 220, 222 in place on the output shaft 218. The upper and lower air bearings 220, 222 may be configured to allow the output shaft 218 to be rotatable about its axis to create rotatable motion of a geometry attached to an end of the output shaft 218 which interacts with a sample under rheological testing (not shown).

The air bearings 220, 222 may be made with upper and lower graphite disks which create an air film between the graphite material and the thrust disk 224 connected to the output shaft 218. The output shaft 218 is configured to move in an axial direction relative to the upper and lower air bearings 220, 222 in response to normal forces +F_{N}, −F_{N} such that movement in the axial direction reduces one of the upper and lower gap 226a, 226b and increases the other of the upper and lower gap 226a, 226b. The various air gaps described herein may be about, for example, 30 micron gaps at a resting state.

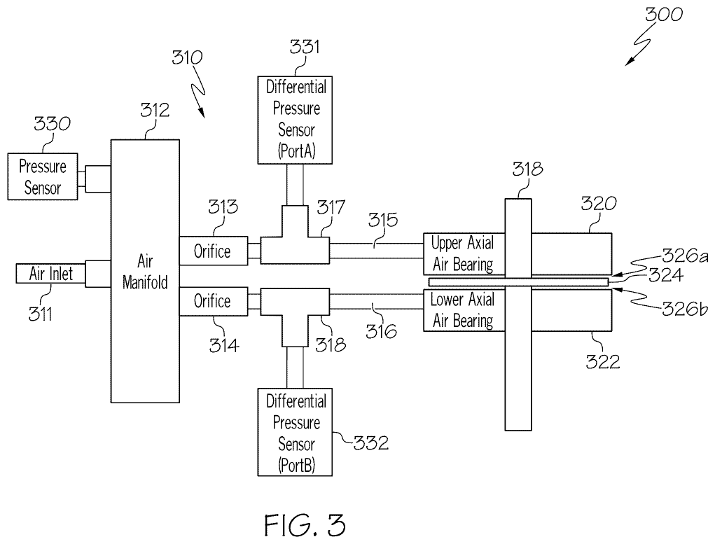

FIG. 3 depicts a schematic side view of a rheometer shaft system 300, in accordance with one embodiment. The rheometer shaft system 300 includes a rheometer output shaft 318, like the rheometer output shaft 218, which includes an axial thrust disk 324. Like the rheometer output shaft 218, an upper air bearing 320 surrounds the output shaft 318 located above the axial thrust disk 324. An upper gap 326a separates the axial thrust disk 324 of the output shaft 318 and the upper air bearing 320. Similarly, a lower air bearing 322 surrounds the output shaft 318 located below the axial thrust disk 324. A lower gap 326b separates the axial thrust disk 324 of the output shaft 318 and the lower air bearing 322.

The rheometer shaft system 300 includes an air supply system 310 configured to provide an airflow to each of an upper air bearing 320 and lower air bearing 322. The air supply system 310 may include an air inlet 311, an air manifold 312, a first reduced orifice 313, a second reduced orifice 314, a first fluidic channel 315 and a second fluidic channel 316. The air inlet 311 may be connected to a compressed air system, such as the compressed air system 126 shown in FIG. 1. For example, the reduced orifices described herein may be 0.4 mm orifices, whereas the air tubes may be much larger in diameter than this reduced diameter (e.g., 2 mm-5 mm). Various orifice sizes are contemplated and the concepts provided herein are not limited to the examples or ranges provided.

The rheometer shaft system 300 further includes an airflow detection system configured to detect a change in airflow to the upper air bearing 320 and the lower air bearing 322 based on the movement of the output shaft 318 in the axial direction relative to the air bearings 320, 322. The airflow detection system includes a first pressure sensor 331 fluidically connected with the first fluidic channel 315 of the air supply system 310 connected to the upper air bearing 320 via a T junction 317 located between the first reduced orifice 313 and the upper axial air bearing 320. The first pressure sensor 331 may be configured to detect a first pressure in the first fluidic channel 315. The airflow detection system further includes a second pressure sensor 332 fluidically connected with a second fluidic channel 316 of the air supply system 310 connected to the lower air bearing 322 via a T junction 318 located between the second reduced orifice 314 and the lower axial air bearing 322. The second pressure sensor 332 configured to detect a second pressure in the second fluidic channel 316. Both the first and the second pressure sensors 331, 332 may be, for example, differential pressure sensors. The airflow detection system further includes a manifold pressure sensor 330 configured to detect a manifold pressure within the air manifold 312.

The first reduced orifice 313 located upstream from the first pressure sensor 331 in the air supply system 310 may be configured to create a controlled pressure drop in the first fluidic channel 315 connected to the upper air bearing 320. Likewise, the second reduced orifice 314 located upstream from the second pressure sensor 332 in the air supply system 310 may be configured to create a controlled pressure drop in the second fluidic channel 316 connected to the lower air bearing 322.

While not shown, the airflow detection system, and the sensors 330, 331, 332 thereof may be connectable to a control system of a rheometer, such as the control system 128 shown in FIG. 1. The control system 128 may include a gap control system configured to vertically move the output shaft 318, the upper bearing 320 and the lower bearing 322 in order to control the position of a geometry located at an end of the output shaft 318 relative to a sample test location (not shown). The gap control system may be configured to automatically respond to a detected change in airflow to the upper air bearing 320 and the lower air bearing 322 based on the movement in the axial direction of the output shaft 318 relative to the upper and lower air bearings 320, 322. Thus, the gap control system may configured to prevent the upper air bearing 320 and the lower air bearing 322 from contacting the axial thrust disk 324 by stopping all motion, including the vertical movement of the output shaft 318, the upper air bearing 320 and the lower air bearing 322, in response to the detected change in airflow to the upper air bearing 320 and the lower air bearing 322 due to the movement in the axial direction of the output shaft 318 relative to the upper and lower air bearings 320, 322. The gap control system may further be configured to reverse a movement. For example, the gap control system may be configured to pull the output shaft 318, and the air bearings 320, 322 upward after a downward motion on the output shaft 318, and the air bearings 320, 322 causes a detected change in airflow indicating one of the air bearings 320, 322 is close to contacting the axial thrust disk 324.

In various embodiments, the detectors or sensors 330, 331, 332 of the present system may further provide detection information to the control system for processing and determination of normal forces. An additional potential value of measuring the normal force using airflow as described herein may be to provide this data to the user (e.g., via the user interface 130) so the user may know if their sample is relaxed before starting a test. The normal force information may tell a user if a sample undergoes compression/tension during testing as well.

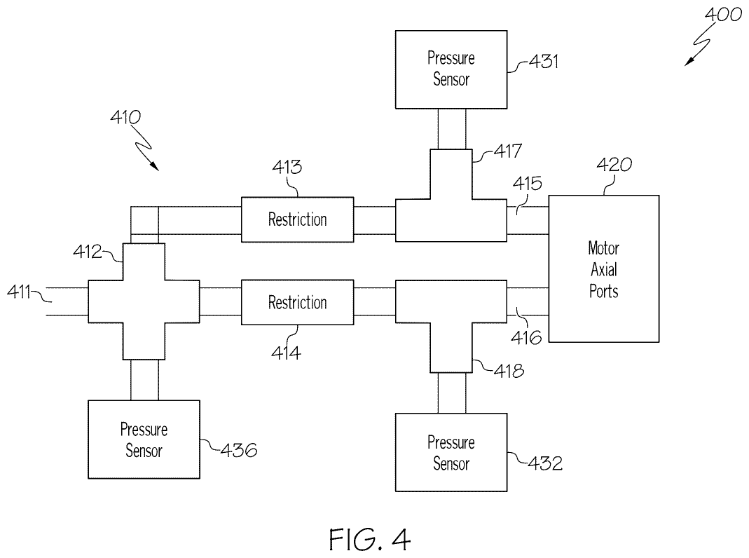

FIG. 4 depicts a schematic side view of a rheometer shaft system 400, in accordance with one embodiment. The rheometer shaft system 400 includes a rheometer output shaft (not shown), like the rheometer output shafts 218, 318 which includes an axial thrust disk, upper air bearing, and lower air bearing configured in the same manner as the embodiments shown in FIGS. 2-3.

The rheometer shaft system 400 includes an air supply system 410 configured to provide an airflow to each of an upper air bearing and lower air bearing via an axial bearing port system 420. The air supply system 410 may include an air inlet 411, an first airflow restrictor 413, a second airflow restrictor 414, a first fluidic channel 415 and a second fluidic channel 416. The air inlet 411 may be connected to a compressed air system, such as the compressed air system 126 shown in FIG. 1.

The rheometer shaft system 400 further includes an airflow detection system configured to detect a change in airflow to the upper air bearing and the lower air bearing based on the movement of the output shaft in the axial direction relative to the air bearings. The airflow detection system includes a first pressure sensor 431 fluidically connected with the first fluidic channel 415 of the air supply system 410. The first pressure sensor 431 is connected to the axial bearing port system 420 via a T junction 417 located between the first airflow restrictor 413 and the axial bearing port system 420. The first pressure sensor 431 may be configured to detect a first pressure in the first fluidic channel 415 which may be connected to the upper air bearing via the axial bearing port system 420. The airflow detection system further includes a second pressure sensor 432 fluidically connected with a second fluidic channel 416 of the air supply system 410. The second pressure sensor 432 is connected to the axial bearing port system 420 via a T junction 418 located between the second reduced orifice 414 and the axial bearing port system 420. The second pressure sensor 432 may be configured to detect a second pressure in the second fluidic channel 416. Both the first and the second pressure sensors 431, 432 may be, for example, differential pressure sensors. The airflow detection system further includes air supply system pressure sensor 430 configured to detect an overall input system air pressure within the air supply system 410.

The first airflow restrictor 413 located upstream from the first pressure sensor 431 in the air supply system 410 may be configured to create a controlled pressure drop in the first fluidic channel 415 connected to the upper air bearing 420 via the axial bearing port system 420. Likewise, the second airflow restrictor 414 located upstream from the second pressure sensor 432 in the air supply system 410 may be configured to create a controlled pressure drop in the second fluidic channel 416 connected to the lower air bearing 422 via the axial bearing port system 420. The airflow restrictors may, for example, be elongated tubing with slightly smaller diameter than the rest of the air supply system, configured to restrict airflow.

While not shown, the airflow detection system, and the sensors 430, 431, 432 thereof may be connectable to a control system of a rheometer, such as the control system 128 shown in FIG. 1. The control system 128 may include a gap control system configured to vertically move the output shaft, the upper bearing and the lower bearings in order to control the position of a geometry located at an end of the output shaft relative to a sample test location. The gap control system may be configured to automatically respond to a detected change in airflow to the upper air bearing and the lower air bearing based on the movement in the axial direction of the output shaft relative to the upper and lower air bearings. Thus, the gap control system may configured to prevent the upper air bearing and the lower air bearing from contacting the axial thrust disk by stopping all motion, including the vertical movement of the output shaft, the upper air bearing and the lower air bearing, in response to the detected change in airflow to the upper air bearing and the lower air bearing due to the movement in the axial direction of the output shaft relative to the upper and lower air bearings. The gap control system may further be configured to reverse a movement. For example, the gap control system may be configured to pull the output shaft and the air bearings upward after a downward motion on the output shaft and the air bearings causes a detected change in airflow indicating one of the air bearings is close to contacting the axial thrust disk.

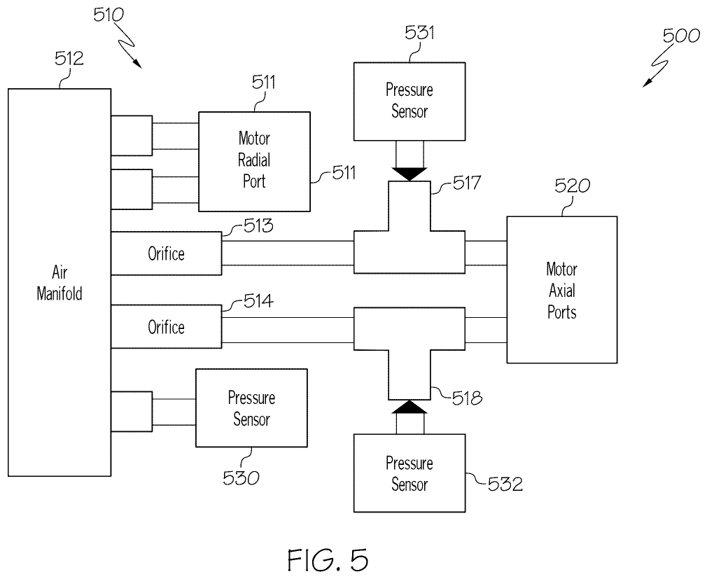

FIG. 5 depicts a schematic side view of a rheometer shaft system 500, in accordance with one embodiment. The rheometer shaft system 500 includes a rheometer output shaft (not shown), like the rheometer output shafts 218, 318, 418 which includes an axial thrust disk, upper air bearing, and lower air bearing configured in the same manner as the embodiments shown in FIGS. 2-4.

The rheometer shaft system 400 includes an air supply system 510 configured to provide an airflow to each of an upper air bearing and lower air bearing via an axial bearing port system 520. The air supply system 510 may include a motor radial port air inlet 511, a manifold 512, a first reduced orifice 513, a second reduced orifice 514, a first fluidic channel 515 and a second fluidic channel 516. The motor radial port air inlet 511 may be connected to a compressed air system, such as the compressed air system 126 shown in FIG. 1.

The rheometer shaft system 500 further includes an airflow detection system configured to detect a change in airflow to the upper air bearing and the lower air bearing based on the movement of the output shaft in the axial direction relative to the air bearings. The airflow detection system includes a first pressure sensor 531 fluidically connected with the first fluidic channel 515 of the air supply system 510. The first pressure sensor 531 is connected to the axial bearing port system 520 via a T junction 517 located between the first airflow restrictor 513 and the axial bearing port system 520. The first pressure sensor 531 may be configured to detect a first pressure in the first fluidic channel 515 which may be connected to the upper air bearing via the axial bearing port system 520. The airflow detection system further includes a second pressure sensor 532 fluidically connected with a second fluidic channel 516 of the air supply system 510. The second pressure sensor 532 is connected to the axial bearing port system 520 via a T junction 518 located between the second reduced orifice 514 and the axial bearing port system 520. The second pressure sensor 532 may be configured to detect a second pressure in the second fluidic channel 516. Both the first and the second pressure sensors 531, 532 may be, for example, differential pressure sensors. The airflow detection system further includes a manifold pressure sensor 530 configured to detect a manifold pressure within the air manifold 512.

The first reduced orifice 513 located upstream from the first pressure sensor 531 in the air supply system 510 may be configured to create a controlled pressure drop in the first fluidic channel 515 connected to the upper air bearing 520. Likewise, the second reduced orifice 514 located upstream from the second pressure sensor 532 in the air supply system 510 may be configured to create a controlled pressure drop in the second fluidic channel 516 connected to the lower air bearing 522.

While not shown, the airflow detection system, and the sensors 530, 531, 532 thereof may be connectable to a control system of a rheometer, such as the control system 128 shown in FIG. 1. The control system 128 may include a gap control system configured to vertically move the output shaft, the upper bearing and the lower bearings in order to control the position of a geometry located at an end of the output shaft relative to a sample test location. The gap control system may be configured to automatically respond to a detected change in airflow to the upper air bearing and the lower air bearing based on the movement in the axial direction of the output shaft relative to the upper and lower air bearings. Thus, the gap control system may configured to prevent the upper air bearing and the lower air bearing from contacting the axial thrust disk by stopping all motion, including the vertical movement of the output shaft, the upper air bearing and the lower air bearing, in response to the detected change in airflow to the upper air bearing and the lower air bearing due to the movement in the axial direction of the output shaft relative to the upper and lower air bearings. The gap control system may further be configured to reverse a movement. For example, the gap control system may be configured to pull the output shaft and the air bearings upward after a downward motion on the output shaft and the air bearings causes a detected change in airflow indicating one of the air bearings is close to contacting the axial thrust disk.

While the shaft systems 300, 400, 500 shown in FIGS. 3-5 include various pressure sensors, the pressure sensors depicted may also be airflow sensors in some embodiments. For example, the first sensors 331, 431, 531 may be airflow sensors fluidically connected with the respective first fluidic channels of the air supply system. Likewise, the second sensors 332, 432, 532 may be airflow sensors fluidically connected with the respective second fluidic channels of the air supply system. The first and second airflow sensors may be configured to detect total airflow through the first and second fluidic channels and provide this information to the gap control system for analysis and gap determination.

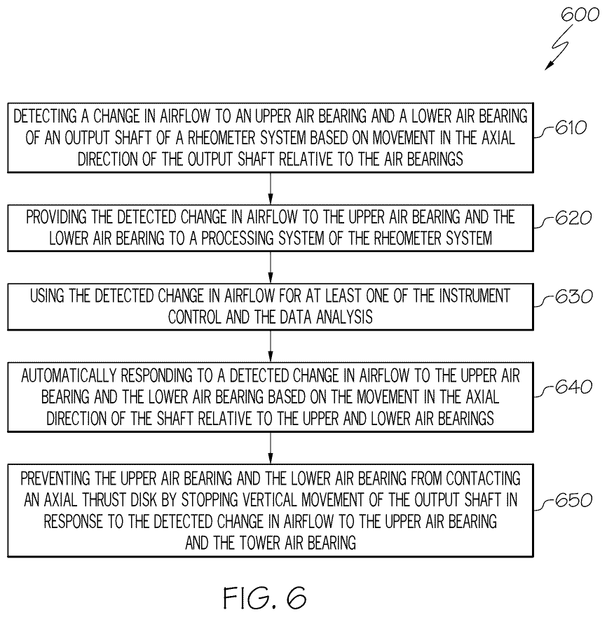

FIG. 6 depicts a flow diagram of a method 600 of measuring a normal force on a shaft of a rheometer, in accordance with one embodiment. The method 600 includes providing a rheometer having one of the various shaft systems 300, 400, 600 described herein above, for example. The method 600 may include a step 610 of detecting, by the airflow detection system, the change in airflow to the upper air bearing and the lower air bearing of the shaft system based on the movement in the axial direction. The method 600 may further include a step 620 of providing the detected change in airflow to the upper air bearing and the lower air bearing to the processing system of the rheometer system and a step 630 of using the detected change in airflow for at least one of the instrument control and the data analysis. The method 600 may further include a step 640 of automatically responding, by a gap control system of the rheometer system, to a detected change in airflow to the upper air bearing and the lower air bearing based on the movement in the axial direction of the shaft relative to the upper and lower air bearings. Still further, the method 600 includes a step 650 of preventing, by the gap control system of the rheometer system, the upper air bearing and the lower air bearing from contacting the axial thrust disk by stopping vertical movement of the output shaft, the upper bearing and the lower bearing in response to the detected change in airflow to the upper air bearing and the lower air bearing based on the movement in the axial direction of the shaft relative to the upper and lower air bearings.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A rheometer shaft system comprising:
an output shaft including an axial thrust disk;
an upper air bearing surrounding the output shaft located above the axial thrust disk, wherein an upper gap separates the axial thrust disk of the output shaft and the upper air bearing;
a lower air bearing surrounding the output shaft located below the axial thrust disk, wherein a lower gap separates the axial thrust disk of the output shaft and the lower air bearing, wherein the output shaft is configured to move in an axial direction relative to the upper and lower air bearings in response to a normal force such that movement in the axial direction reduces one of the upper and lower gap and increases the other of the upper and lower gap;
an air supply system configured to provide an airflow to each of the upper air bearing and the lower air bearing; and
an airflow detection system configured to detect a change in airflow to the upper air bearing and the lower air bearing based on the movement in the axial direction.

2. The rheometer shaft system of claim 1, wherein the airflow detection system further comprises:
a first pressure sensor fluidically connected with a first fluidic channel of the air supply system connected to the upper air bearing, the first pressure sensor configured to detect a first pressure in the first fluidic channel; and
a second pressure sensor fluidically connected with a second fluidic channel of the air supply system connected to the lower air bearing, the second pressure sensor configured to detect a second pressure in the second fluidic channel.

3. The rheometer shaft system of claim 2, wherein the first pressure sensor and the second pressure sensors are differential pressure sensors.

4. The rheometer shaft system of claim 2, wherein the airflow detection system further comprises:
a first reduced orifice located upstream from the first pressure sensor in the air supply system configured to create a controlled pressure drop in the first fluidic channel connected to the upper air bearing; and
a second reduced orifice located upstream from the second pressure sensor in the air supply system configured to create a controlled pressure drop in the second fluidic channel connected to the lower air bearing.

5. The rheometer shaft system of claim 2, wherein the airflow detection system further comprises:
a first airflow restrictor structure located upstream from the first pressure sensor in the air supply system configured to create a controlled pressure drop in the first fluidic channel connected to the upper air bearing; and
a second airflow restrictor structure located upstream from the second pressure sensor in the air supply system configured to create a controlled pressure drop in the second fluidic channel connected to the lower air bearing.

6. The rheometer shaft system of claim 1, wherein the airflow detection system further comprises:
a first airflow sensor fluidically connected with a first fluidic channel of the air supply system connected to the upper air bearing, the first airflow sensor configured to detect a first total airflow through the first fluidic channel; and
a second airflow sensor fluidically connected with a second fluidic channel of the air supply system connected to the lower air bearing, the second airflow sensor configured to detect a second total airflow through the second fluidic channel.

7. The rheometer shaft system of claim 1, further comprising:
a gap control system configured to vertically move the output shaft, the upper bearing and the lower bearing in order to control the position of a geometry located at an end of the output shaft relative to a sample test location.

8. The rheometer shaft system of claim 7, wherein the gap control system is configured to automatically respond to a detected change in airflow to the upper air bearing and the lower air bearing based on the movement in the axial direction of the shaft relative to the upper and lower air bearings.

9. The rheometer shaft system of claim 8, wherein the gap control system is configured to prevent the upper air bearing and the lower air bearing from contacting the axial thrust disk by stopping vertical movement of the output shaft, the upper bearing and the lower bearing in response to the detected change in airflow to the upper air bearing and the lower air bearing based on the movement in the axial direction of the shaft relative to the upper and lower air bearings.

10. A rheometer system comprising:
a sample test location;
the rheometer shaft system of claim 1;
a sensor system configured to detect measurements from the rheometer shaft system associated with interactions between a test sample in the sample test location and a geometry attached to an end of the output shaft; and
a processing system in communication with the sensor system, the processing system configured to provide for instrument control, data collection and data analysis based on the detected measurements.

11. The rheometer system of claim 10, wherein the airflow detection system further comprises:
a first pressure sensor fluidically connected with a first fluidic channel of the air supply system connected to the upper air bearing, the first pressure sensor configured to detect a first pressure in the first fluidic channel; and
a second pressure sensor fluidically connected with a second fluidic channel of the air supply system connected to the lower air bearing, the second pressure sensor configured to detect a second pressure in the second fluidic channel.

12. The rheometer system of claim 11, wherein the first pressure sensor and the second pressure sensors are differential pressure sensors.

13. The rheometer system of claim 11, wherein the airflow detection system further comprises:
a first reduced orifice located upstream from the first pressure sensor in the air supply system configured to create a controlled pressure drop in the first fluidic channel connected to the upper air bearing; and
a second reduced orifice located upstream from the second pressure sensor in the air supply system configured to create a controlled pressure drop in the second fluidic channel connected to the lower air bearing.

14. The rheometer system of claim 11, wherein the airflow detection system further comprises:
a first airflow restrictor structure located upstream from the first pressure sensor in the air supply system configured to create a controlled pressure drop in the first fluidic channel connected to the upper air bearing; and
a second airflow restrictor structure located upstream from the second pressure sensor in the air supply system configured to create a controlled pressure drop in the second fluidic channel connected to the lower air bearing.

15. The rheometer system of claim 10, wherein the airflow detection system further comprises:
a first airflow sensor fluidically connected with a first fluidic channel of the air supply system connected to the upper air bearing, the first airflow sensor configured to detect a first total airflow through the first fluidic channel; and
a second airflow sensor fluidically connected with a second fluidic channel of the air supply system connected to the lower air bearing, the second airflow sensor configured to detect a second total airflow through the second fluidic channel.

16. The rheometer system of claim 10, further comprising the geometry attached to the end of the output shaft configured to interact with the test sample in the sample test location.

17. A method of measuring a normal force on a shaft of a rheometer, the method comprising:
providing the rheometer system of claim 10;
detecting, by the airflow detection system, the change in airflow to the upper air bearing and the lower air bearing based on the movement in the axial direction.

18. The method of claim 17, further comprising:
providing the detected change in airflow to the upper air bearing and the lower air bearing to the processing system of the rheometer system; and
using the detected change in airflow for at least one of the instrument control and the data analysis.

19. The method of claim 17, further comprising:
automatically responding, by a gap control system of the rheometer system, to a detected change in airflow to the upper air bearing and the lower air bearing based on the movement in the axial direction of the shaft relative to the upper and lower air bearings.

20. The method of claim 17, further comprising:
preventing, by the gap control system of the rheometer system, the upper air bearing and the lower air bearing from contacting the axial thrust disk by stopping vertical movement of the output shaft, the upper bearing and the lower bearing in response to the detected change in airflow to the upper air bearing and the lower air bearing based on the movement in the axial direction of the shaft relative to the upper and lower air bearings.
